(19) United States
(12) Patent Application Publication
(10) Pub. No.: US 2006/0075419 A1
(43) Pub. Date: Apr. 6, 2006

(54) Information recording medium

(75) Inventors: Koji Mishima, Tokyo (JP); Daisuke Yoshitoku, Tokyo (JP); Kenji Yamaga, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 10/958,663

(22) Filed: Oct. 6, 2004

(51) Int. Cl. G11B 3/70; G11B 5/84; G11B 7/26; G11B 7/24

(52) U.S. Cl. 720/718; 369/283

(57) ABSTRACT

An information recording medium includes a recording layer sandwiched between a pair of resin layers and has a track pitch in a range of 0.1 μm to 0.5 μm, inclusive. The recording layer has a higher refractive index than the pair of resin layers, is composed of a single layer of recording material of a same type, and is formed so that both surfaces thereof directly contact the pair of resin layers. At least one resin layer out of the pair of resin layers is formed with a refractive index in a range of 1.2 to 1.5, inclusive.

### BACKGROUND OF THE INVENTION

1. Field of the Invention

The present invention relates to an information recording medium including a recording layer sandwiched between a pair of resin layers.

2. Description of the Related Art

An optical recording medium (information recording medium) that includes a recording layer sandwiched between a pair of resin layers and for which data can be recorded and read by irradiation with laser light is conventionally known. With this optical recording medium, data is read based on changes in the intensity of reflected light for the laser light emitted toward the recording layer. Accordingly, to make it possible to read data properly, the optical recording medium needs to be constructed so that the reflectivity is a predetermined value or higher. For this reason, to increase the reflectivity, modern optical recording media usually use a construction where a reflective layer of a material such as metal is formed between the recording layer and a resin layer. As one example of this type of optical recording medium, Japanese Laid-Open Patent Publication No. 2003-157580 discloses an optical information recording medium constructed so that a cover layer made up of an adhesive layer and a sheet-like substrate is provided on a multilayer structure made up of a transparent substrate, a reflective layer, a second protective layer, a recording layer and a first protective layer. In this case, the reflective layer, the second protective layer, the recording layer, and the first protective layer are formed by sputtering.

However, the above conventional optical information recording medium has the following problems. That is, in the above optical information recording medium, the reflective layer, the second protective layer, the recording layer, and the first protective layer (hereinafter, collectively referred to as “functional layers” when no distinction is required) are formed by sputtering. Under present conditions where price competition for information recording media is becoming fierce, it is important to simplify the manufacturing process so as to reduce manufacturing costs. However, when manufacturing the above conventional optical information recording medium, at least four sputtering operations are necessary to form the functional layers and due to such processes, there is the problem that it is difficult to reduce the manufacturing cost. Also, an expensive sputtering apparatus including a plurality of chambers is required to form the functional layers, and due to the initial cost of such apparatus, there is the problem that it is even more difficult to reduce the manufacturing cost.

### SUMMARY OF THE INVENTION

The present invention was conceived in view of the problems described above and it is a principal object to provide an information recording medium that can reduce the manufacturing cost while achieving a reflectivity that is required for the proper reading of data.

To achieve the stated object an information recording medium according to the present invention includes a recording layer sandwiched between a pair of resin layers and has a track pitch in a range of 0.1 μm to 0.5 μm, inclusive, wherein the recording layer has a higher refractive index than the pair of resin layers, is composed of a single layer of recording material of a same type, and is formed so that both surfaces thereof directly contact the pair of resin layers, and at least one resin layer out of the pair of resin layers is formed with a refractive index in a range of 1.2 to 1.5, inclusive. It should be noted that the expression “recording material of a same type” for the present invention includes materials where there are somewhat different proportions of the elements composing the recording material.

In the above information recording medium, by sandwiching a recording layer, which has a higher refractive index than the respective refractive indices of the resin layers and is composed of a single layer of recording material of a same type, between the pair of resin layers, and forming at least one resin layer out of the pair of resin layers with a refractive index in a range of 1.2 to 1.5, inclusive, it is possible to achieve a sufficiently high reflectivity for data to be read properly, so that it is possible to manufacture an information recording medium for which data can be reliably read without including a reflective layer. Accordingly, it is possible to simplify the manufacturing process of an information recording medium by an amount corresponding to the omission of a sputtering process for forming a reflective layer. It is also possible to use a sputtering apparatus whose construction is simplified by an amount corresponding to the omission of part of the sputtering process, so that the initial cost can be sufficiently reduced. As a result, it is possible to sufficiently reduce the manufacturing cost of an information recording medium.

In this case, it is possible to use a construction where the at least one resin layer out of the pair of resin layers is formed at a position closer to an incident side than the recording layer in an irradiation direction of laser light used to read data. With this construction, a higher reflectivity can be achieved compared to a construction formed so that the refractive index of the resin layer positioned on a transmission side than the recording layer in an incident direction for laser light used to read data is in the range of 1.2 to 1.5, inclusive.

Also, both resin layers out of the pair of resin layers may be formed with the respective refractive indices thereof in a range of 1.2 to 1.5, inclusive. With this construction, it is possible to achieve a higher reflectivity, so that data can be read more reliably.

Also, the recording material can be composed of a material whose main components are Bi and O. With this construction, by using a recording material formed so that the proportion of the number of O atoms to the total number of Bi and O atoms is in a range of 63% to 77%, inclusive, it is possible to reliably record and read data using a blue or blue-violet laser.

### BRIEF DESCRIPTION OF THE DRAWINGS

These and other objects and features of the present invention will be explained in more detail below with reference to the attached drawings, wherein:

FIG. 1 is a cross-sectional view of an optical recording medium; and

FIG. 2 is a cross-sectional view of a substrate, a recording layer, and a light transmitting layer.

### DESCRIPTION OF THE PREFERRED EMBODIMENTS

Preferred embodiments of an information recording medium according to the present invention will now be described with reference to the attached drawings.

First, the construction of an optical recording medium 1 will be described with reference to the drawings.

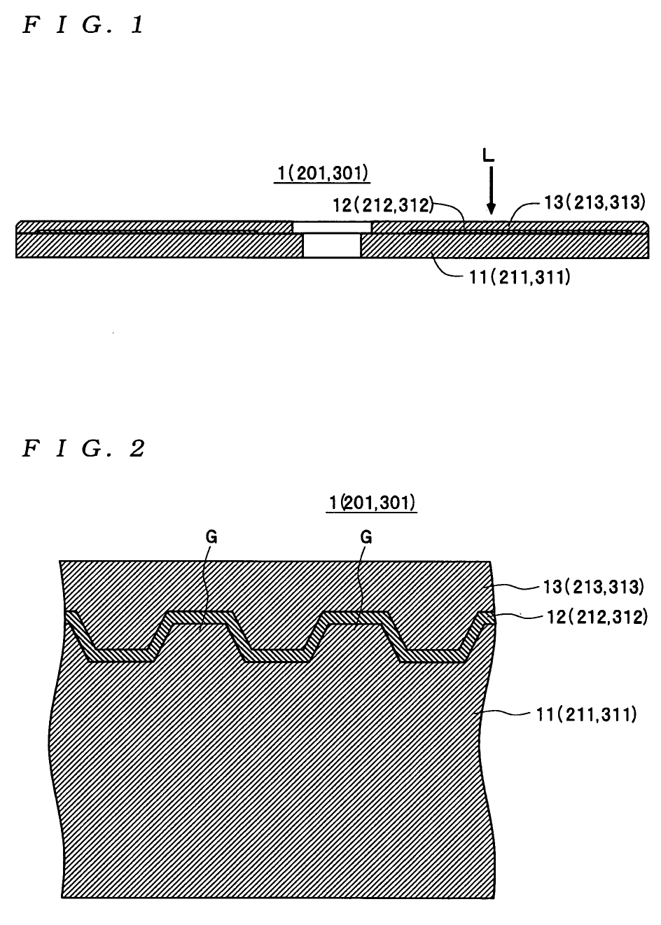

The optical recording medium 1 is one example of an information recording medium according to the present invention and as shown in FIG. 1, includes a substrate 11, a recording layer 12 formed on a surface (the upper surface in FIG. 1) of the substrate 11, and a light transmitting layer 13 formed so as to cover the recording layer 12. Also, as shown in FIG. 1, the optical recording medium 1 is constructed so that data can be recorded and read by irradiation with blue or blue-violet laser light L with a wavelength (λ) in a range of 350 nm to 450 nm, inclusive (as one example, laser light L with a wavelength of 405 nm) from the light transmitting layer 13 side.

The substrate 11 corresponds to one resin layer out of “the pair of resin layers” for the present invention and is formed in a disc shape (a plate-like shape) with a diameter of around 120 mm and a thickness of around 1.2 mm by injection molding an acrylic resin that transmits light and has a refractive index of around 1.45. It should be noted that the resin for forming the substrate 11 is not limited to acrylic resin and it is also possible to use various types of resin (such as fluororesin, silicon resin, polyacetal, and polypropylene) that transmit light and have a refractive index in a range of 1.2 to 1.5, inclusive. Also, as shown in FIG. 2, on one surface (the upper surface in FIG. 2) of the substrate 11, a groove that protrudes toward an incident side for the laser light L is formed in a spiral from a central part of the substrate 11 to the outer edge part. In this case, the groove G functions as a track for recording and reading data on the recording layer 12. Accordingly, to make proper tracking possible, as one example, the groove G is formed with a height in a range of 15 nm to 25 nm, inclusive and with a pitch (track pitch) between adjacent parts of the groove G, G in a range of 0.1 μm to 0.5 μm, inclusive. It should be noted that it is also possible to have a land (a concave part) function as the track, and on such a substrate, the land is formed with a depth in the above range of 15 nm to 25 nm, inclusive and with a pitch between adjacent parts of the land in the above range of 0.1 μm to 0.5 μm, inclusive. It is also possible to have both the groove and the land function as tracks, and on such a substrate, the groove and the land are formed so that the depth from the upper surface of the groove on the incident side for the laser light L to the bottom surface of the land is formed in the above range of 15 nm to 25 nm, inclusive and the pitch between adjacent parts of the groove G and the land is in the above range of 0.1 μm to 0.5 μm, inclusive.

The recording layer 12 is a layer whose optical characteristics (as one example, the refractive index) change when the laser light L is irradiated during the recording of data to form recording marks, and is formed on the surface of the substrate 11 by sputtering, for example. The recording layer 12 is constructed of a single layer using a recording material that has predetermined elements as main components and is formed so that a lower surface thereof directly contacts the upper surface of the substrate 11 and an upper surface thereof directly contacts a lower surface of the light transmitting layer 13. That is, the recording layer 12 is sandwiched between the substrate 11 and the light transmitting layer 13 with no other functional layers in between. The recording layer 12 is also formed with a refractive index of 2.45 (one example of “a higher refractive index than respective refractive indices of the pair of resin layers” for the present invention). In addition, the recording layer 12 is formed with a thickness in a range of 13 nm to 74 nm, inclusive. A recording material that has Zn, Si, Mg, O and S as main components, a recording material that has La, Si, Mg, O and S as main components, and a recording material that has Bi and O as main components, and the like can be used as the recording material that composes the recording layer 12. Here, the recording material that has Zn, Si, Mg, O and S as main components should preferably be formed so that the relative proportions of the respective elements (the proportions of the number of atoms of the respective elements relative to the total number of atoms of all elements) are 21.5%, 10.1%, 20.8%, 20.1%, and 27.5%, respectively. Also, the recording material that has La, Si, Mg, O and S as main components should preferably be formed so that the relative proportions of the respective elements are 6.2%, 24.1%, 23.1%, 24.6% and 22.0%, respectively.

On the other hand, for a recording layer 12 constructed using the recording material that has Bi and O as main components, when the laser light L for recording data is irradiated, it is believed that unstable materials such as Bi₂O₄ and Bi₂O₅ included in the recording material are broken down to the stable materials Bi₂O₃ and 02, with hollows being produced in the recording layer 12 by the 02, that is, recording marks being formed. The present inventors confirmed by experimentation that when a recording material in which the proportion of O atoms with respect to the total number of Bi and O atoms (this proportion is hereinafter referred to as the “O proportion”) exceeds 77% is used, the proportion of Bi₂O₄ and Bi₂O₅ included in the recording layer 12 (the recording material) is too high, which makes the entire recording layer 12 unstable, while when a recording material with an O proportion of below 63% is used, the proportion of Bi₂O₄ and Bi₂O₅ is too low, so that it is difficult to form favorable recording marks. Accordingly, to make it possible to reliably form favorable recording marks from which data can be reliably read, the recording material that has Bi and O as main components should preferably be formed so that the O proportion is in a range of 63% to 77%, inclusive. In addition, the present inventors confirmed by experimentation that a recording layer 12 produced using the recording material that has Bi and O as main components has superior storage characteristics compared to recording layers 12 produced using the other recording materials. Accordingly, out of the recording materials described above, the recording material that has Bi and O as main components should preferably be used as the recording material that composes the recording layer 12.

In addition, the recording layer 12 can be constructed so as to internally include parts where the relative proportions of the respective elements described above differ somewhat from one another. More specifically, as one example in a central part in the thickness direction of the recording layer 12, the relative proportions of Bi and O can be set at 30% and 70%, respectively, while at the parts close to the substrate 11 and the light transmitting layer 13, the relative proportions can be set at 40% and 60%, respectively. In this case, when a difference between a maximum value and a minimum value of the relative proportion of O is set in a range of +20%, by controlling the flow rate of O₂ gas supplied inside the chamber, it is possible to form the recording layer 12 using a single sputtering apparatus (a single chamber), so that the time taken and cost incurred by the formation process of the recording layer 12 can be reduced.

The light transmitting layer 13 corresponds to another resin layer out of “the pair of resin layers” for the present invention, and is formed by applying a resin that is hardened by energy rays (as one example, UV rays) with a thickness of around 100 μm by spin coating. In this case, an acrylic resin that transmits light and has a refractive index of around 1.45 is used as the resin that is hardened by energy rays. It should be noted that in place of the acrylic resin, it is also possible to use various types of energy ray-hardened resin (such as fluororesin, silicon resin, polyacetal, polypropylene, and the like) that transmit light and have a refractive index of 1.2 to 1.5, inclusive. The method of forming the light transmitting layer 13 is not limited to spin coating, and it is also possible to use a method that sticks on a film formed of the various types of resin described above.

Next, the method of manufacturing the optical recording medium 1 will be described with reference to the drawings.

First, the substrate 11 is fabricated by injection molding an acrylic resin that transmits light and has a refractive index of about 1.45. A convex/concave pattern of a stamper that has been set inside an injection molding mold is transferred to form a convex/concave pattern (the groove G) in the surface side of the substrate 11. Here, the convex/concave pattern of the stamper is formed so that the height of the groove G is in a range of 15 nm to 25 nm, inclusive and the pitch of the groove G is in a range of 0.1 μm to 0.5 μm, inclusive.

Next, a sputtering apparatus is used to form the recording layer 12 on a surface of the substrate 11 in which the convex/concave pattern has been formed. More specifically, a Bi target is set in the chamber of the sputtering apparatus and the substrate 11 is disposed inside the chamber. Next, O₂ gas is supplied inside the chamber at a flow rate of 15 sccm, for example. Next, Ar gas is supplied inside the chamber as a sputtering gas at a flow rate of 50 sccm, for example, and collides with the Bi target. At this time, the Bi particles that are scattered by the collisions with the sputtering gas accumulate on the substrate 11 while reacting with the O₂ gas inside the chamber and oxidizing. Here, the sputtering conditions are adjusted so that the proportion of the number of O atoms to the total number of Bi and O atoms is in a range of 63% to 77%, inclusive. By doing so, as shown in FIG. 2, the recording layer 12 is formed with a substantially equal thickness along the convex/concave pattern of the substrate 11. It should be noted that although it is preferable to construct the recording layer 12 mainly of Bi and O, it is also possible to include other atoms, compounds, or the like, provided that the amount of such is small. In this case, when the included amount of other atoms, compounds, or the like is too high, the relative amount of Bi and O in the recording layer 12 falls, which makes it difficult to form recording marks from which data can be read reliably. Accordingly, the mixed proportion of other atoms, compounds, or the like aside from Bi and O should preferably be 25% or below.

Next, the light transmitting layer 13 is formed so as to cover the recording layer 12 by spin coating. More specifically, the substrate 11 is placed on a turntable in a state where the surface on which the recording layer 12 has been formed faces upwards. Next, a UV-hardening acrylic resin that transmits light and has a refractive index of about 1.45 is dripped onto a central part of the substrate 11 while the turntable is rotated at low speed. Next, the turntable is rotated at high speed. At this time, the acrylic resin spreads with a substantially even thickness toward the outer circumferential part of the substrate 11 due to the centrifugal force that accompanies the rotation. Next, UV rays are irradiated onto the spread-out acrylic resin. By doing so, as shown in FIG. 2, the acrylic resin is hardened by the irradiation of the UV rays to form the light transmitting layer 13 so as to cover the recording layer 12. In this way, the optical recording medium 1 that includes the recording layer 12 which is sandwiched by the substrate 11 and the light transmitting layer 13 is completed.

Next, results of measuring the optical characteristics of the optical recording medium 1 will be described.

Before measuring was carried out, an optical recording medium 1 was manufactured in accordance with the method of manufacturing described above. In this case, the groove G with a height of 20 nm and a pitch of 0.32 μm was formed in the surface of the substrate 11. Also, the recording layer 12 was formed with a thickness of 20 nm and the light transmitting layer 13 was formed with a thickness of 100 μm. As a comparative example, an optical recording medium 101 including a substrate 111, a recording layer 112, and a light transmitting layer 113 was also manufactured. In this case, polycarbonate resin was used for the substrate 111, but aside from this, the substrate 111 was fabricated with the same specification as the substrate 11. The recording layer 112 was formed with a thickness of 20 nm using a recording material that has Bi and O as main components, where the proportion of O atoms to the total number of Bi and O atoms was 70%. Also, epoxy resin was used for the light transmitting layer 113, but aside from this, the light transmitting layer 113 was fabricated with the same specification as the light transmitting layer 13.

Next, an optical film thickness measuring apparatus (ETA-RT) manufactured by ETA-OPTIK is used to measure the respective refractive indices of the substrate 11, the recording layer 12, and the light transmitting layer 13 of the optical recording medium 1, and the substrate 111, the recording layer 112, and the light transmitting layer 113 of the optical recording medium 101. As a result, as shown in Table 1, the refractive indices of the substrate 11, the recording layer 12, and the light transmitting layer 13 were 1.45, 2.45, and 1.45, respectively. On the other hand, the refractive indices of the substrate 111, the recording layer 112, and the light transmitting layer 113 were 1.55, 2.45, and 1.55, respectively.

TABLE 1

| | Refractive | |
|---|---|---|
| | Index | Reflectivity |
| SUBSTRATE 11 | 1.45 | — |
| RECORDING LAYER 12 | 2.45 | — |
| LIGHT TRANSMITTING LAYER 13 | 1.45 | — |
| OPTICAL RECORDING MEDIUM 1 | — | 5.2% |
| SUBSTRATE 111 | 1.55 | — |
| RECORDING LAYER 112 | 2.45 | — |
| LIGHT TRANSMITTING LAYER 113 | 1.55 | — |
| OPTICAL RECORDING MEDIUM 101 | — | 3.9% |

Next, using an optical recording medium evaluating apparatus (DDU1000) manufactured by PULSTEC INDUSTRIAL CO., LTD, the reflectivity of the optical recording medium 1 and the optical recording medium 101 when the media are irradiated with laser light L with a wavelength of 405 nm was measured. As a result, as shown in Table 1, the reflectivity of the optical recording medium 1 was 5.2%. On the other hand, the reflectivity of the optical recording medium 101 was 3.9%. Here, the present inventors confirmed by experimentation that the reading of data is carried out reliably when the reflectivity of the optical recording medium is 4.0% or above and the reading of the data is insufficient when the reflectivity of the optical recording medium is below 4.0%. Accordingly, from the above measurement results, it is clear that a sufficient reflectivity for reading data can be obtained when the recording layer 12 is formed with a higher refractive index than the refractive indices of the substrate 11 and the light transmitting layer 13 and the substrate 11 and the light transmitting layer 13 have been formed so that the respective refractive indices thereof are 1.45 that is within the range of 1.2 and 1.5, inclusive.

In this way, according to the optical recording medium 1, by sandwiching the recording layer 12 that has a higher refractive index than the refractive indices of the substrate 11 and the light transmitting layer 13 between the substrate 11 and the light transmitting layer 13 without other functional layers in between and forming at least one of the substrate 11 and the light transmitting layer 13 so that the refractive index thereof is 1.45, it is possible to achieve a sufficient reflectivity for the proper reading of data. Accordingly, since it is possible to manufacture the optical recording medium 1 for which data can be reliably read without providing a reflective layer, it is possible to simplify the manufacturing process of the optical recording medium 1 by an amount equivalent to the omission of the sputtering process for forming the reflective layer. Since it is also possible to use a sputtering apparatus with a construction simplified to an extent equivalent to the omission of part of the sputtering process, a sufficient reduction can be made in the initial cost. As a result, it is possible to definitely reduce the manufacturing cost of the optical recording medium 1.

Also, by forming both the substrate 11 and the light transmitting layer 13 so that the respective refractive indices thereof are 1.45, it is possible to achieve an even higher reflectivity, so that data can be read even more reliably.

Also, by forming the recording layer 12 using the recording material that has Bi and O as main components, for example, by using a recording material where the proportion of O atoms to the total number of Bi and O atoms is in a range of 63% to 77%, inclusive, it is possible to reliably record and read data using blue or blue-violet laser light L (i.e., laser light with a wavelength of around 350 to 450 nm).

It should be noted that the present invention is not limited to the above construction. For example, although the present invention has been described by way of the optical recording medium 1 in which both the substrate 11 and the light transmitting layer 13 are formed so that the refractive indices thereof are 1.45, it is also possible to use an optical recording medium 201 in which only the light transmitting layer (a “resin layer positioned on the incident side for laser light” for the present invention) is formed so that the refractive index thereof is in a range of 1.2 to 1.5, inclusive. In this case, the optical recording medium 201 is constructed of a substrate 211, a recording layer 212, and a light transmitting layer 213. When manufacturing the optical recording medium 201, in place of the acrylic resin used to fabricate the substrate 11 of the optical recording medium 1, the substrate 211 can be fabricated using a resin (such as a styrene acrylonitrile copolymer, epoxy resin, polystyrene, polycarbonate, polysulfone, and phenol resin) whose refractive index exceeds 1.5. It should be noted that the light transmitting characteristics of the optical recording medium 201 were measured in the same way as described above. In this case, aside from the use of polycarbonate, the substrate 211 was fabricated with the same specification as the substrate 11 of the optical recording medium 1. The recording layer 212 and the light transmitting layer 213 were also formed with the same specification as the recording layer 12 and the light transmitting layer 13 of the optical recording medium 1. As shown in Table 2, the measurement results were that the refractive indices of the substrate 211, the recording layer 212, and the light transmitting layer 213 were 1.55, 2.45, and 1.45, respectively. In addition, as shown in Table 2, the reflectivity of the optical recording medium 201 was 5.0%. From these results, it is clear that when the recording layer 212 is formed with a higher refractive index than those of the substrate 211 and the light transmitting layer 213, and the light transmitting layer 213 is formed with a refractive index of 1.45 that is in a range of 1.2 to 1.5, inclusive, a sufficient reflectivity for the proper reading of data is achieved. Accordingly, in the same way as the optical recording medium 1, the optical recording medium 201 can definitely reduce manufacturing costs.

TABLE 2

| | Refractive | |
|---|---|---|
| | Index | Reflectivity |
| SUBSTRATE 211 | 1.55 | — |
| RECORDING LAYER 212 | 2.45 | — |
| LIGHT TRANSMITTING LAYER 213 | 1.45 | — |
| OPTICAL RECORDING MEDIUM 201 | — | 5.0% |

It is also possible to use an optical recording medium 301 formed so that the refractive index of only the substrate (“at least one of the resin layers” for the present invention) is in the range of 1.2 to 1.5, inclusive. In this case, the optical recording medium 301 includes a substrate 311, a recording layer 312, and a light transmitting layer 313. When the optical recording medium 301 is manufactured, in place of the acrylic resin used to fabricate the light transmitting layer 13 of the optical recording medium 1, the light transmitting layer 313 can be fabricated using a resin (such as a styrene acrylonitrile copolymer, epoxy resin, polystyrene, polycarbonate, polysulfone, and phenol resin) whose refractive index exceeds 1.5. It should be noted that the light transmitting characteristics of the optical recording medium 301 were measured in the same way as described above. In this case, aside from the use of epoxy resin, the light transmitting layer 313 was fabricated with the same specification as the light transmitting layer 13 of the optical recording medium 1. The substrate 311 and the recording layer 312 were also formed with the same specification as the substrate 11 and the recording layer 12 of the optical recording medium 1. As shown in Table 3, the measurement results were that the refractive indices of the substrate 311, the recording layer 312, and the light transmitting layer 313 were 1.45, 2.45, and 1.55, respectively. In addition, as shown in Table 3, the reflectivity of the optical recording medium 301 was 4.2%. From these results, it is clear that when the recording layer 312 is formed with a higher refractive index than the respective refractive indices of the substrate 311 and the light transmitting layer 313, and the substrate 311 is formed with a refractive index of 1.45 that is in a range of 1.2 to 1.5, inclusive, a sufficient reflectivity for the proper reading of data is achieved. Accordingly, in the same way as the optical recording medium 1 and the optical recording medium 201, the optical recording medium 301 can definitely reduce manufacturing costs.

TABLE 3

| | Refractive | |
|---|---|---|
| | Index | Reflectivity |
| SUBSTRATE 311 | 1.45 | — |
| RECORDING LAYER 312 | 2.45 | — |
| LIGHT TRANSMITTING LAYER 313 | 1.55 | — |
| OPTICAL RECORDING MEDIUM 301 | — | 4.2% |

Although the present invention has been described with the optical recording media 1, 201, 301 in which only one recording layer 12 is formed as examples, the present invention can also be applied to a multilayer information recording medium that includes a plurality of recording layers sandwiched between pairs of resin layers. It is also possible to apply the present invention to a multilayer information recording medium that includes recording layers sandwiched between resin layers on both surfaces of a substrate. In addition, it is possible to apply the present invention to a multilayer information recording medium constructed by sticking together recording layers, which have been formed on inner surfaces of a pair of substrates, with an adhesive layer as another resin layer.

What is claimed is:

1. An information recording medium that includes a recording layer sandwiched between a pair of resin layers and has a track pitch in a range of 0.1 μm to 0.5 μm, inclusive,
wherein the recording layer has a higher refractive index than the pair of resin layers, is composed of a single layer of recording material of a same type, and is formed so that both surfaces thereof directly contact the pair of resin layers, and
at least one resin layer out of the pair of resin layers is formed with a refractive index in a range of 1.2 to 1.5, inclusive.

2. An information recording medium according to claim 1,
wherein the at least one resin layer out of the pair of resin layers is formed at a position closer to an incident side than the recording layer in an irradiation direction of laser light used to read data.

3. An information recording medium according to claim 1,
wherein both resin layers out of the pair of resin layers are formed with the respective refractive indices thereof in a range of 1.2 to 1.5, inclusive.

4. An information recording medium according to claim 1,
wherein the recording material is composed of a material whose main components are Bi and O.

5. An information recording medium according to claim 2,
wherein the recording material is composed of a material whose main components are Bi and O.

6. An information recording medium according to claim 3,
wherein the recording material is composed of a material whose main components are Bi and O.
